(19) United States
(12) Patent Application Publication
(10) Pub. No.: US 2007/0127725 A1
(43) Pub. Date: Jun. 7, 2007

(54) Thin electronic circuit device

(75) Inventors: Atsushi Tominaga, Fukushima-ken (JP); Hiromi Yokoyama, Fukushima-ken (JP); Keitaro Uchida, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/602,840

(22) Filed: Nov. 20, 2006

(30) Foreign Application Priority Data
Dec. 7, 2005 (JP) 2005-353270

(51) Int. Cl. H04H 5/00

(52) U.S. Cl. 381/2

(57) ABSTRACT

On the side of a first main surface of a module base, a transmitter is provided which includes wiring patterns formed on the first main surface and electronic components provided on the wiring patterns. On the side of a second main surface of the module base, a receiver is provided which includes wiring patterns formed on the second main surface and electronic components provided on the wiring patterns. A motherboard has an opening formed therein, and an electronic circuit module is mounted on the motherboard, with the receiver inserted into the opening.

### BACKGROUND OF THE INVENTION

1. Field of the Invention

The present invention relates to an electronic circuit device in which an electronic circuit module including a plurality of circuits provided on a module base is mounted on a motherboard.

2. Description of the Related Art

An FM (frequency modulation) transceiver has been proposed which includes an FM tuner (receiver) for receiving an FM signal and an FM transmitter for transmitting an FM signal obtained by converting an audio signal.

FIG. 7 is a block diagram showing an example of the configuration of an FM transceiver. A tuner module 101 is a FM tuner module serving as a receiver. A transmitter module 102 is a FM transmitter module serving as a transmitter. An antenna 103 for receiving an FM signal is connected to the tuner module 101, and an antenna 104 for transmitting an FM signal is connected to the transmitter module 102. When an antenna is shared by the receiver and the transmitter, an antenna switch for antenna switching is provided. The tuner module 101 and the transmitter module 102 include microcomputers 105 and 106, respectively. By respectively supplying control signals to the microcomputers 105 and 106 through buses 107 and 108, operations of the microcomputers 105 and 106 are controlled. A reference signal is supplied from an external crystal oscillator to built-in PLL (phase-locked loop) circuits of the tuner module 101 and the transmitter module 102 via separate lines. The tuner module 101 and the transmitter module 102 can separately be supplied with power via a power selection switch 109.

Module bases of the tuner module 101 and the transmitter module 102 are mounted on a motherboard. On the motherboard, signals lines, such as antenna lines, audio lines, reference signal lines, and power lines, extended from the modules 101 and 102, are routed for wiring.

Among known front-end modules which switch between circuits (transmitting and receiving circuits) to be connected to an antenna, there has been proposed a type of front-end module including a transmitting circuit and a receiving circuit on one surface of a multilayer board. In addition, an electronic circuit module has been proposed in which a top surface of a circuit-pattern-formed multilayer board has thereon chip components such as multilayer capacitors and multilayer inductors, and semiconductor components, and in which a cavity formed in a bottom surface of the multilayer board accommodates components.

However, when a plurality of circuits are provided on one surface of the multilayer board as in an electronic circuit module of the related art, an area occupied for mounting the electronic circuit module is large, thus causing difficulty in size reduction.

In addition, as in another electronic circuit module of the related art, when components are provided in a cavity formed in an opposite surface of a multilayer board, the multilayer board increases in thickness for the height of the cavity. Consequently, when the electronic circuit module is mounted on a motherboard, the electronic circuit module is in a state with its thickness directly protruding from the motherboard. This is not preferable from size reduction and thickness reduction viewpoints.

### SUMMARY OF THE INVENTION

The present invention has been made in view of the above circumstance. It is an object of the present invention to provide an electronic circuit device having a module area reduced without reducing the number of circuits and a reduced thickness protruding from a motherboard.

The present invention provides a thin electronic circuit device including a thin electronic circuit module including an insulating base having first and second main surfaces opposite to each other, a first circuit provided on the side of the first main surface of the insulating base, the first circuit including a wiring pattern formed on the first main surface and an electronic component provided on the wiring pattern formed on the first main surface, and a second circuit provided on the side of the second main surface of the insulating base, the second circuit including a wiring pattern formed on the second main surface and an electronic component provided on the wiring pattern formed on the second main surface, and a motherboard on which the electronic circuit module is mounted in a state in which a portion of the second circuit protruding from the second main surface is inserted into an opening formed at a position for mounting the electronic circuit module.

According to the above configuration, since the first and second circuits are provided in distributed form on the first and second main surfaces of the insulating base, and the electronic circuit module is mounted on the motherboard, with the portion of the second circuit inserted into the opening formed in the motherboard, the area of the electronic circuit module can be reduced and heights, protruding from the motherboard, of portions of the first and second circuits can be reduced.

Preferably, the area of the second circuit provided on the side of the second main surface of the insulating base is smaller than the area of the first circuit provided on the side of the first main surface of the insulating base, and external connection terminals are formed around the second circuit provided on the side of the second main surface.

In this configuration, the area of a second circuit portion inserted into the opening in the motherboard is smaller than that of a first circuit portion. Thus, the opening in the motherboard can be more reduced and processing of the motherboard can be minimized.

In addition, in the electronic circuit device, the first circuit may include a transmitting circuit for converting a baseband signal into a radio frequency signal and an antenna switching circuit for switching between sections connected to an antenna, the second circuit may include a receiving circuit for demodulating a received radio frequency signal output from the antenna into a baseband signal, and the insulating base may include, as an inner layer, at least one ground layer for the first and second circuits.

In this configuration, since the transmitting circuit is provided on the first main surface of the insulating base and a receiving circuit is provided on the second main surface of the insulating base, a small electronic circuit module obtained by modularizing the transmitting and receiving circuits can be provided and interference between the transmitting and receiving circuits can be prevented.

In the electronic circuit device, the first circuit may include a receiving circuit for demodulating a received radio frequency signal output from an antenna and an antenna switching circuit for switching between sections connected to the antenna, the second circuit may include a transmitting circuit for modulating a baseband signal into a radio frequency signal, and the insulating base may include, as an inner layer, at least one ground layer for the first and second circuits.

In the electronic circuit device, the first circuit may be covered with a first metallic cover, the second circuit may be covered with a second metallic cover, and the external connection terminals may be formed outside the second metallic cover.

Therefore, even if a radio frequency signal is sent with large transmission power from the transmitting circuit, the first metallic cover can shield a signal directly leaking from the transmitting circuit from which the radio frequency signal is transmitted. In addition, the second metallic cover can shield a signal from the antenna and the transmitting circuit to the receiving circuit.

In the electronic circuit device, the transmitting circuit may be a frequency modulation transmitter, and the receiving circuit may be a frequency modulation tuner.

Furthermore, in the electronic circuit device, the first and second circuits may include first and second phase-locked loop circuits, respectively, and a microcomputer for controlling the first and second circuits and a reference signal generating circuit for supplying a reference signal to the first and second phase-locked loop circuits may be provided on the motherboard.

According to the present invention, the area of an electronic circuit module provided with a plurality of circuits can be reduced, and a thickness that protrudes from a motherboard when the electronic circuit module is mounted on the motherboard can be reduced.

### BRIEF DESCRIPTION OF THE DRAWINGS

FIG. 1 is a block diagram showing the entirety of an FM transceiver according to an embodiment of the present invention;

FIG. 2 is a functional block diagram of the FM transceiver shown in FIG. 1;

FIG. 3 is a sectional view showing a sectional structure of an electronic circuit module of each of a transmitter and receiver in the FM transceiver according to the embodiment of the present invention;

FIG. 4A is a top view of the electronic circuit module shown in FIG. 3, and FIG. 4B is a bottom view of the electronic circuit module shown in FIG. 3;

FIG. 5 consists of exterior views of the electronic circuit module shown in FIG. 3 and a motherboard, and an exterior view of the motherboard, with the electronic circuit module mounted thereon;

FIG. 6 is a schematic side view of a motherboard with an electronic circuit module mounted thereon; and

FIG. 7 is a block diagram showing the entirety of a known FM transceiver including separately modularized transmitter and receiver.

### DESCRIPTION OF THE PREFERRED EMBODIMENTS

An embodiment of the present invention is described below in detail with reference to the accompanying drawings.

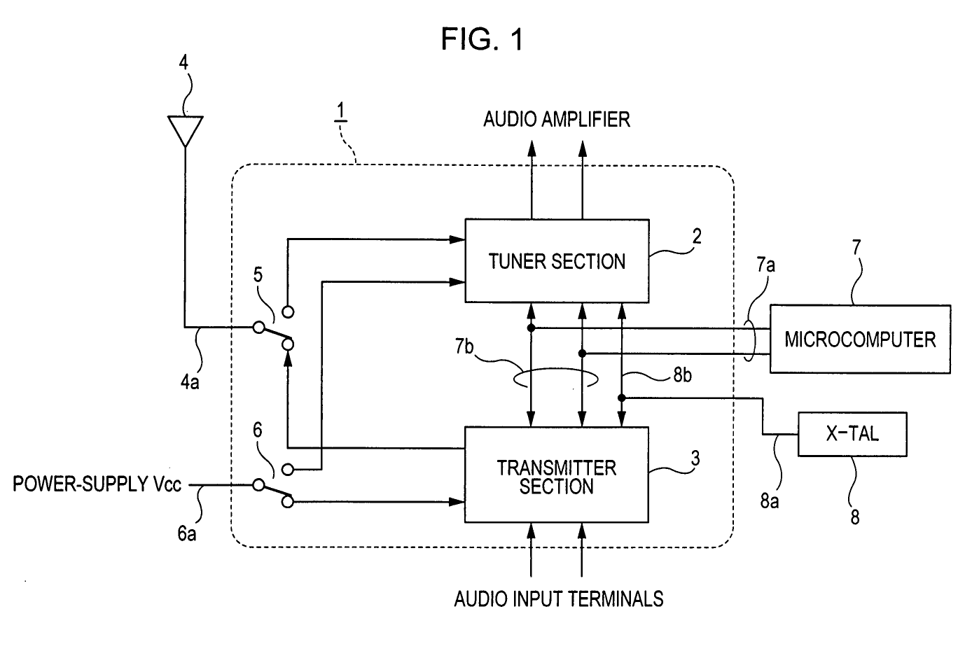

FIG. 1 is a schematic functional block diagram of an FM transceiver according to the embodiment of the present invention. In the FM transceiver shown in FIG. 1, an electronic circuit module 1 forms a transmitter and a receiver. The electronic circuit module 1 includes a tuner section 2 that is a circuit for realizing an FM tuner function and a transmitter section 3 that is a circuit for realizing an FM transmitter function. The tuner section 2 and the transmitter section 3 are provided on a module base, and the electronic circuit module 1 is mounted on a motherboard.

An antenna 4 is connected to one end of an antenna changeover switch 5 via a common signal line 4a. The other end of the antenna changeover switch 5 is selectively connected to the tuner section 2 and the transmitter section 3. A power supply (Vcc) is connected to one end of a power selection switch 6 via a common power-supply line 6a. The other end of the power selection switch 6 is selectively connected to the tuner section 2 and the transmitter section 3. A microcomputer 7 is connected to buses 7b via common signal lines 7a. The buses 7b connect to the tuner section 2 and the transmitter section 3. A crystal oscillator 8 is connected to a bus 8b via a common signal line 8a. The bus 8b connects to the tuner section 2 and the transmitter section 3. Output terminals of the tuner section 2 are connected to an audio amplifier provided on the side of a motherboard. Input terminals of the transmitter section 3 are connected to audio input terminals provided on the side of the motherboard.

As described above, an FM tuner and an FM transmitter are provided as the electronic circuit module 1 alone, whereby the signal lines 4a, 6a, 7a, and 8a, which are extended from the electronic circuit module 1 to the antenna 4, the microcomputer 7, the crystal oscillator 8, and the power supply, can be used in common. Therefore, signal line routing on the motherboard, on which the module base of the electronic circuit module 1 is mounted, can be simplified, thus enabling suppression in interference between the signal lines.

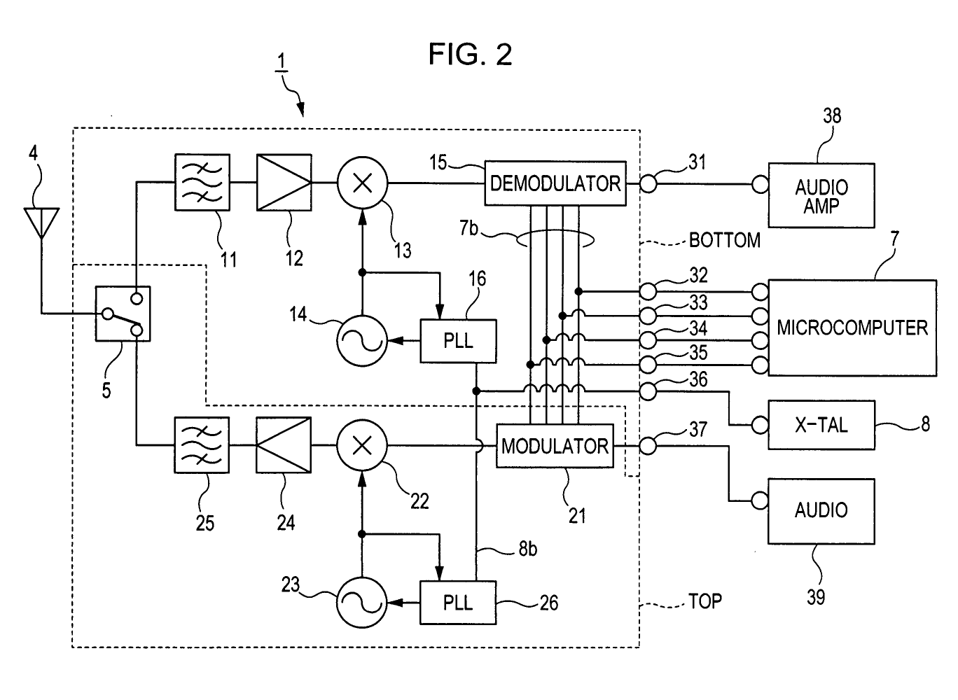

FIG. 2 is a block diagram of the FM transceiver according to the embodiment and mainly shows a circuit configuration of the electronic circuit module 1. The tuner section 2 includes a bandpass filter 11 for allowing a targeted frequency to pass through it, a radio frequency amplifier 12 for amplifying a received FM signal, a mixer 13 for performing frequency conversion on the amplified received FM signal, a local oscillator 14 for generating a local oscillation signal, a demodulator 15 for outputting an audio signal by demodulating the frequency-converted received signal, and a PLL circuit 16 for generating a phase control signal on the basis of a reference signal. The transmitter section 3 includes a modulator 21 for modulating the audio signal into a transmitting signal, a mixer 22 for performing frequency conversion on the transmitting signal to generate an FM signal, a local oscillator 23 for generating a local oscillation signal, a radio frequency amplifier 24 for amplifying the frequency-converted FM signal, a bandpass filter 25 for allowing a targeted frequency to pass through it, and a PLL circuit 26 for generating a phase control signal on the basis of a reference signal.

In the electronic circuit module 1, a plurality of external connection terminals 31 to 37 are provided in the periphery of a bottom surface of the module base. An output end of the demodulator 15 in the electronic circuit module 1 and an input end of an audio amplifier 38 outside the electronic circuit module 1 are connected to the external connection terminal 31. The buses 7b in the electronic circuit module 1 and the microcomputer 7 outside the electronic circuit module 1 are connected to the external connection terminals 32 to 35. The bus 8b in the electronic circuit module 1 and the crystal oscillator 8 outside the electronic circuit module 1 are connected to the external connection terminal 36. An input end of the modulator 21 in the electronic circuit module 1 and an audio output terminal 39 outside the electronic circuit module 1 are connected to the external connection terminal 37.

In the embodiment, the circuit elements (21 to 26) and antenna changeover switch 5 included in transmitter section 3 as the transmitter are disposed on the side of the top surface (first main surface) of the electronic circuit module 1, and the circuit elements (11 to 16) included in the tuner section 2 as the receiver are disposed on the side of the bottom surface (second main surface) of the electronic circuit module 1.

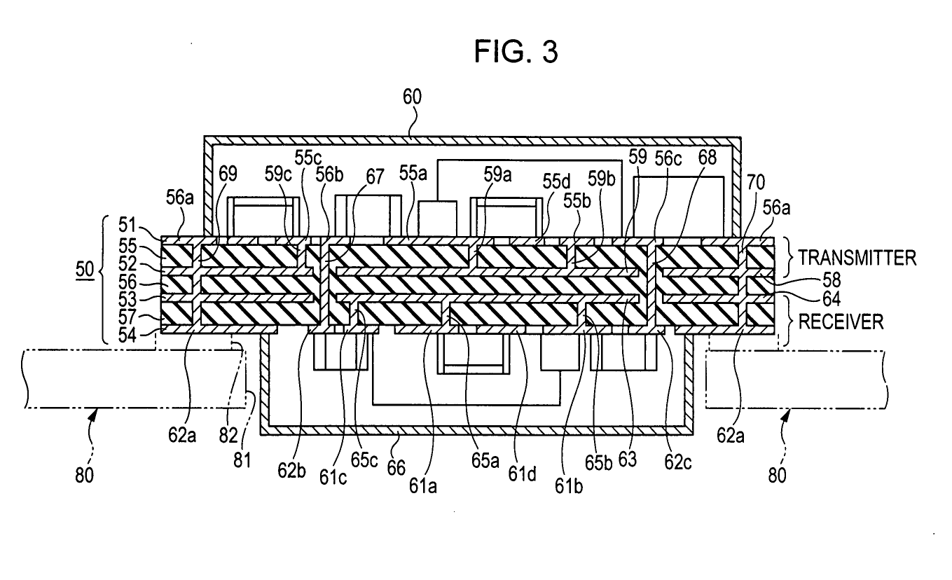

FIG. 3 is a sectional view showing a sectional structure of the electronic circuit module 1. A module base 50 has a first main surface formed on a top base surface and a second main surface as a bottom base surface. On the side of the first main surface (including not only the top base surface but also part of inner layers), a first circuit forming the transmitter is formed, while, on the side of the second main surface (including not only the bottom base surface but also part of inner layers), a second circuit forming the receiver is formed. The module base 50 is formed by a multilayer board including first to fourth layers 51 to 54 formed by conductive layers and insulating layers 55 to 57 insulating interlayers of the first to fourth layers 51 to 54.

The first layer 51 includes a plurality of wiring patterns formed on the first main surface. Wiring patterns 55a to 55d formed in the first layer 51 in the central portion of the first main surface mainly form part of radio frequency components of the transmitter and are provided with electronic components of the transmitter. The radio frequency components of the transmitter include the modulator 21, the mixer 22, the local oscillator 23, the radio frequency amplifier 24, the bandpass filter 25, and the PLL circuit 26 which are shown in FIG. 2. A wiring pattern 56a that is formed in a periphery outside an arrangement area of the electronic components of the transmitter in the first layer 51 is conductively connected to through-holes 69 and 70 conductively connecting the first layer 51 to the fourth layer 54. Wiring patterns 56b and 56c formed in an intermediate area of the first layer 51 are conductively connected by through-holes 67 and 68 for predetermined wiring patterns (62b, 62c) formed in the fourth layer 54. Portions that conductively connect the first layer 51 and the fourth layer 54 by the through-holes 67 and 68 correspond to the signal lines and power-supply line formed between the transmitter and receiver shown in FIGS. 1 and 2. The electronic components of the transmitter include the antenna changeover switch 5. The antenna changeover switch 5 inputs a received signal to the receiver on the side of the second main surface via the through-hole 67 or 68.

A second layer 52 is formed as an inner layer on the side of the first main surface. The second layer 52 forms a first ground layer that functions as the ground of the transmitter on the side of the first main surface. The wiring patterns 55a to 55c forming the ground pattern of the first layer 51 are conductively connected by through-holes 59a to 59c to a central ground portion 59 opposing the arrangement area of the radio frequency components of the transmitter. Through-holes 69 and 70 connecting the first layer 51 to the fourth layer 54 are conductively connected to a peripheral ground portion 58 outside the arrangement area of the radio frequency components of the transmitter.

For the first main surface of the module base 50, an upper cover 60 made of metal is provided. The upper cover 60 is closely fixed to the wiring pattern 56a formed in the periphery of the first layer 51. The electronic components (of the transmitter) and antenna changeover switch 5 provided on the first main surface are accommodated in the upper cover 60.

The fourth layer 54 includes a plurality of wiring patterns formed on the second main surface. Wiring patterns 61a to 61d that are formed in the fourth layer 54 in a central portion of the second main surface mainly form part of radio frequency components of the receiver and are provided with electronic components of the receiver. The radio frequency components of the receiver include the bandpass filter 11, the radio frequency amplifier 12, the mixer 13, the local oscillator 14, the demodulator 15, and the PLL circuit 16 which are shown in FIG. 2. A wiring pattern 62a that is formed in the fourth layer 54 in the periphery outside the arrangement area of the electronic components of the receiver are conductively connected to the through-holes 69 and 70 conductively connecting the first layer 51 to the fourth layer 54. Wiring patterns 62b and 62c formed in an intermediate area of the fourth layer 54 are conductively connected to the Wiring patterns 56b and 56c of the first layer 51 by the through-holes 67 and 68. The periphery of the second main surface of the module base 50 which corresponds to a formation area of the wiring pattern 62a is provided with a plurality of external connection terminals. The wiring pattern 62a shown in FIG. 3 forms a ground terminal among the external connection terminals.

The third layer 53 is formed as an inner layer on the side of the second main surface. The third layer 53 forms a second ground layer that functions as the ground of the receiver on the side of the second main surface. The wiring patterns 61a to 61c included in the fourth layer 54 are conductively connected by through-holes 65a to 65c to a central ground portion 63 opposing the arrangement area of the radio frequency components of the receiver. The through-holes 69 and 70 connecting the first layer 51 to the fourth layer 54 are conductively connected to a peripheral ground portion 64 outside the arrangement area of the radio frequency components of the receiver.

A lower cover 66 made of metal is provided for the second main surface of the module base 50. The lower cover 66 is closely fixed to the wiring pattern 62a formed in an intermediate portion of the fourth layer 54. The electronic components of the receiver which are mounted on the second main surface are accommodated in the upper cover 60. External connection terminals including the wiring pattern 62a in the periphery of the second main surface of the module base 50 are disposed outside the lower cover 66. As shown in FIG. 3, an area provided with the external connection terminals in the second main surface of the module base 50 extends outward from the lower cover 66.

As shown in FIG. 2, on the top side (the first main surface) of the module base 50, the transmitter and the antenna changeover switch 5 are provided, and, on the bottom side (the second main surface) of the module base 50, the receiver is provided. Thus, assuming that the transmitter and the receiver are almost equal to each other in occupied area, the occupied area on the first main surface of the module base 50 is greater for the antenna changeover switch 5. As shown in FIG. 3, the upper cover 60 for the first main surface of the module base 50 is larger in size than the lower cover 66 for the second main surface of the module base 50.

The second layer 52 serving as the first ground layer and the third layer 53 serving as the second ground layer are conductively connected to the wiring pattern 62a of the fourth layer 54 serving as the ground layer by the through-holes 69 and 70. In this embodiment, the through-holes 69 and 70 are formed in the periphery of the module base 50, which is outside the arrangement areas of the radio frequency components and electronic components of the transmitter and the receiver. The electronic circuit module 1 is mounted on a motherboard 80 indicated by the two-dot chain lines shown in FIG. 3. A relationship between the motherboard 80 and the electronic circuit module 1 is described later.

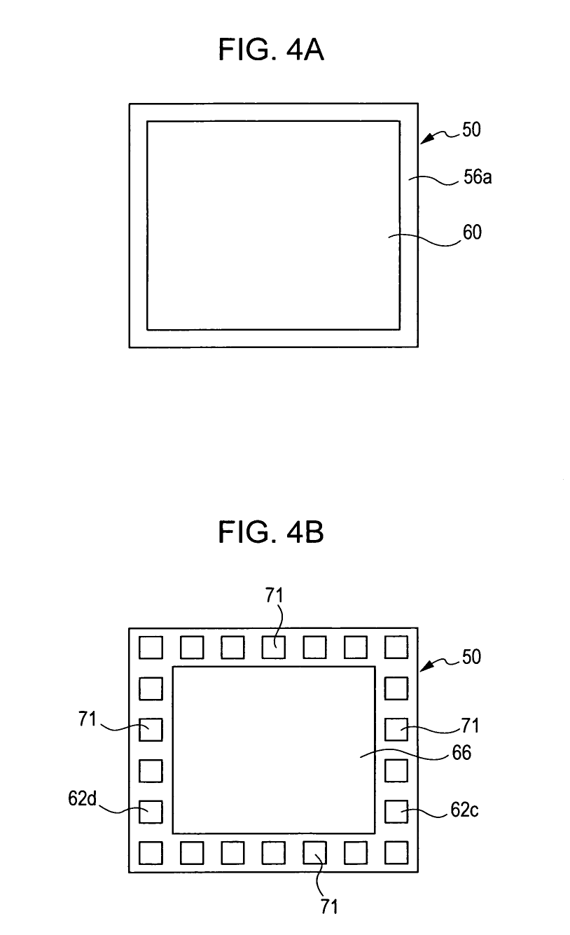

FIG. 4A is a top view of the electronic circuit module 1, and the FIG. 4B is a bottom view of the electronic circuit module 1. As shown in FIG. 4A, the upper cover 60, which is square-shaped, is mounted on the top surface of the module base 50, which is substantially square-shaped, with a base periphery (outer edge of the wiring pattern 56a) slightly exposed.

As shown in FIG. 4B, external connection terminals 71 are formed at predetermined intervals in the periphery of the bottom surface of the module base 50. The wiring pattern 62a formed in the periphery of the fourth layer 54 is positioned outside the lower cover 66, and corresponds to the external connection terminals 31 to 37 shown in FIG. 2. In other words, the external connection terminals 31 to 37 are disposed outside the lower cover 66 on the second main surface of the module base 50. Among the external connection terminals 71 shown in FIG. 4B, the ground terminal is formed by the wiring pattern 62a in the fourth layer 54.

As shown in FIGS. 3, 4A, and 4B, the lower cover 66 is smaller in size (area) than the upper cover 60. By employing a configuration in which the receiver on the side of the second main surface is located in the center of the module base 50, the periphery of the module base 50 protrudes outward from a peripheral wall of the lower cover 66 covering the receiver. The external connection terminals 71 (31 to 37) for electrically connecting to the exterior are provided in the periphery of the module base 50 outside the peripheral wall of the lower cover 66.

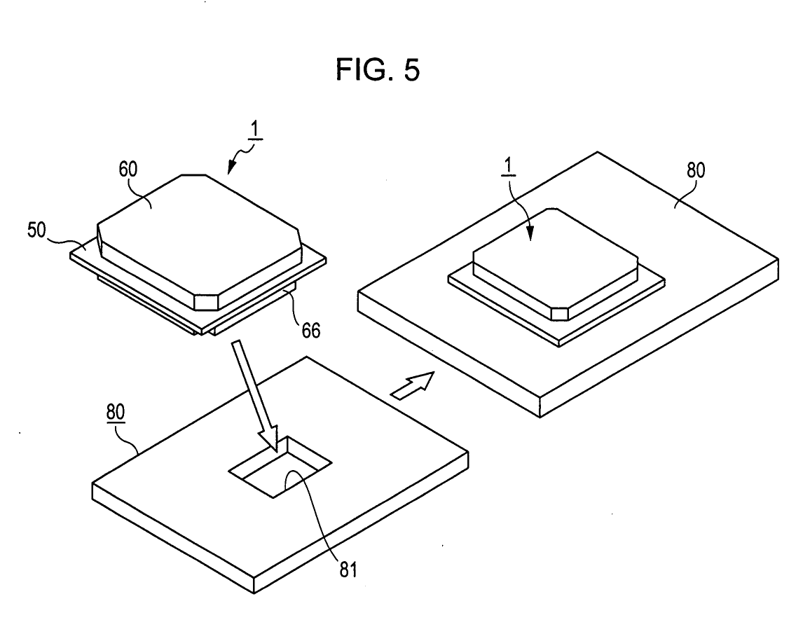

FIG. 5 consists of exterior views of the electronic circuit module 1, the motherboard 80, and a state in which the electronic circuit module 1 is mounted on the motherboard 80. The microcomputer 7, the crystal oscillator 8, etc., which are circuit components other than the transmitter and the receiver, are mounted on the motherboard 80. The electronic circuit module 1, which has transmitter and receiver functions of an FM transceiver, is mounted at a predetermined position on the motherboard 80.

An opening 81 is formed at a mounting position for mounting the electronic circuit module 1 in the motherboard 80. The opening 81 has a shape matching an exterior size of the lower cover 66 for the electronic circuit module 1. By inserting the lower cover 66 for the electronic circuit module 1 into the opening 81, and engaging the periphery (of the second main surface of the module base 50) which extends outward from the lower cover 66 with the top surface of the motherboard 80 in the outer edge of the opening 81, positioning of the electronic circuit module 1 to the motherboard 80 can be performed.

As described above, the external connection terminals 71 are formed in the periphery of the second main surface of the module base 50. In the outer edge of the opening 81 of the motherboard 80, a plurality of module connection terminals 82 that are connected to electronic devices (such as the microcomputer 7 and the crystal oscillator 8) on the motherboard 80 are formed. The module connection terminals 82 of the motherboard 80 are set so as to be positioned opposing the external connection terminals 71 of the electronic circuit module 1 whose positioning is performed by inserting the lower cover 66 into the opening 81 of the motherboard 80. Therefore, by performing the positioning of the electronic circuit module 1 to the opening 81 of the motherboard 80, the electronic devices (such as the microcomputer 7 and the crystal oscillator 8) on the motherboard 80 can be connected to the electronic components of the electronic circuit module 1.

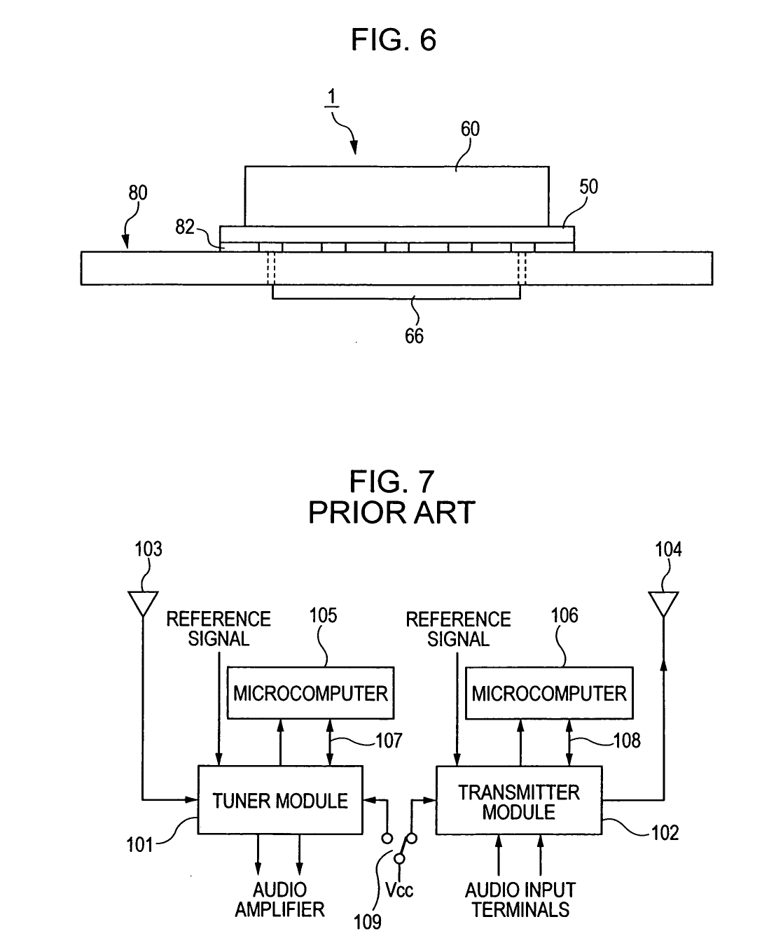

FIG. 6 is a side view of the motherboard 80, with the electronic circuit module 1 mounted thereon. A distance that is the sum of the thicknesses of the module base 50 and the module connection terminals 82, and the height of the upper cover 60 protrudes upward from the top surface of the motherboard 80. In addition, a distance that is obtained by subtracting the thickness of the motherboard 80 form the height of the lower cover 66 protrudes from the bottom surface of the motherboard 80. In other words, although the electronic circuit module 1 alone increases in thickness for the height of the lower cover 66 provided on the bottom surface of the module base 50, by employing a structure in which the lower cover 66 is fixedly fitted into the opening 81 of the motherboard 80, in a state in which the electronic circuit module 1 is mounted on the motherboard 80, protrusion from the motherboard 80 can be reduced to a level that is not so different from a case in which circuits are provided on only one surface of the module base 50.

In the electronic circuit module 1 having the above-described configuration, the wiring patterns 55a to 55d, 56b, and 56c provided on the side of the first main surface of the module base 50, and the electronic components mounted on them constitute the transmitter. In the transmitter, a baseband signal (such as an audio signal component) input from the external connection terminals 71 on the side of the first main surface of the module base 50 is converted into a radio frequency transmitting signal. The radio frequency transmitting signal is output from the antenna changeover switch 5 to the external connection terminals 71 on the second main surface through the through-hole 69 or 70. The output radio frequency transmitting signal is sent to the motherboard again through the module connection terminals 82 touching the external connection terminals 71, and is transmitted from the antenna 4.

In addition, the wiring patterns 61a to 61d, 62b, and 62c on the side of the second main surface of the module base 50, and the electronic components mounted on them constitute the receiver. A radio frequency signal is received by the antenna 4 and is input to the receiver through the antenna changeover switch 5. The receiver converts the received radio frequency signal into a baseband signal. The baseband signal is sent from module connection terminals 82 connected to the external connection terminals 71 to an audio amplifier 38 on the side of the motherboard 80.

In this embodiment, the transmitter is provided on the side of the first main surface of the module base 50, while the receiver is provided on the side of the second main surface opposite to the first main surface. Thus, on the first main surface of the module base 50, it is only necessary to reserve an area for providing the transmitter and the antenna changeover switch 5, and, on the second main surface of the module base 50, it is only necessary to reserve an area for providing the receiver. Accordingly, compared with a case in which the transmitter and the receiver are provided on either surface of the module base 50, the area of the electronic circuit module 1 can greatly be reduced, thus realizing size reduction.

In addition, the electronic circuit module 1 is configured so that the opening 81 is formed in the motherboard 80 and the lower cover 66 protruding on the side of the second main surface is inserted into the opening 81. Thus, the protrusion occurring by mounting the electronic circuit module 1 on the motherboard 80 can be reduced to a level similar to that in the related art on the side of the top surface of the motherboard 80. In addition, also on the side of the bottom surface of the motherboard 80, the protrusion can be reduced to such a level that the lower cover 66 slightly protrudes.

Furthermore, by accommodating the antenna changeover switch 5 in the upper cover 60, the lower cover 66 is made smaller than the upper cover 60 in size. Thus, the area of the opening 81 formed in the motherboard 80 can be reduced, so that processing of the motherboard 80 can be minimized.

The transmitter is provided on the side of the first main surface of the module base 50, the receiver is provided on the side of the second main surface opposite to the first main surface, and the ground layer (the second layer 52) of the transmitter and the ground layer (the third layer 53) of the receiver are formed as inner layers. Thus, compared with a configuration in which the transmitter and the receiver are adjacently provided on the same base surface, the transmitter and the receiver can completely be separated, thus preventing interference between both.

The first ground layer (the second layer 52) serving as the ground of the transmitter and the second ground layer (the third layer 53) serving as the ground of the receiver are conductively connected to each other outside the circuit elements of the transmitter and the receiver by the through-holes 69 and 70, and are conductively connected to a ground terminal (the wiring pattern 62a), whose potential is stable. Thus, a structure in which interference hardly occurs is realized.

The upper cover 60 made of metal that covers the transmitter provided on the side of the first main surface of the module base 50 is connected to the first ground layer (the second layer 52), and the lower cover 66 made of metal that covers the receiver provided on the side of the second main surface of the module base 50 is connected to the second ground layer (the third layer 53). Thus, the potential of the upper cover 60 and the potential of the lower cover 66 can be separated, thus preventing interference between the transmitter and the receiver.

In the above description, the transmitter and the antenna changeover switch 5 are provided on the side of the first main surface of the module base 50. However, also by providing the receiver and the antenna changeover switch 5 on the side of the first main surface of the module base 50, and providing the transmitter on the side of the second main surface of the module base 50, with the transmitter covered with the lower cover 66, similar operation and advantages can be obtained.

An example in which the transmitter and receiver of the FM transceiver are formed by a single module has been described. However, the present invention is not limited to an electronic circuit module of the transmitter and receiver of the FM transceiver. When each of various electronic circuits includes first and second circuits to be provided in module form, by providing the first circuit on the side of a first main surface of a module base, providing the second circuit on the side of a second main surface of the module base, and forming, in the motherboard, an opening into which the second circuit is inserted, a height of the electronic circuit module protruding from the motherboard can be reduced.

Although the second layer 52 is used as the first ground layer, and the third layer 53 is used as the second ground layer, for each of the first and second circuits, a plurality of ground layers may be provided. When a circuit configuration is complex, by increasing the ground layers, an effect of suppression between the circuits can be improved. Conversely, when the height of the electronic circuit module 1 is preferentially lowered, by using a single layer as the second layer 52 and third layer 53 in the module base 50, the thickness of the module base 50 can be reduced. In addition, instead of using a multilayer base, the module base 50 may be formed by a double-sided base.

In addition, instead of only using the wiring patterns of the first layer 51 and the fourth layer 54 to form the first and second circuits, by adding different conductive layers to an inner layer portion, a wiring pattern in a plurality of layers can form a circuit on the side of each of the first and second main surfaces.

The present invention is applicable to an electronic circuit device in which an electronic circuit module having a plurality of circuits as a single module is mounted on a motherboard.

What is claimed is:

1. A thin electronic circuit device comprising:
a thin electronic circuit module including an insulating base having first and second main surfaces opposite to each other, a first circuit provided on the side of the first main surface of the insulating base, the first circuit including a wiring pattern formed on the first main surface and an electronic component provided on the wiring pattern formed on the first main surface, and a second circuit provided on the side of the second main surface of the insulating base, the second circuit including a wiring pattern formed on the second main surface and an electronic component provided on the wiring pattern formed on the second main surface; and
a motherboard on which said thin electronic circuit module is mounted in a state in which a portion of the second circuit protruding from the second main surface is inserted into an opening formed at a position for mounting said thin electronic circuit module.

2. The thin electronic circuit device according to claim 1, wherein:
the area of the second circuit provided on the side of the second main surface of the insulating base is smaller than the area of the first circuit provided on the side of the first main surface of the insulating base; and
external connection terminals are formed around the second circuit provided on the side of the second main surface.

3. The thin electronic circuit device according to claim 1, wherein:
the first circuit includes a transmitting circuit for converting a baseband signal into a radio frequency signal and an antenna switching circuit for switching between sections connected to an antenna;
the second circuit includes a receiving circuit for demodulating a received radio frequency signal output from the antenna into a baseband signal; and
the insulating base includes, as an inner layer, at least one ground layer for the first and second circuits.

4. The thin electronic circuit device according to claim 1, wherein:
the first circuit includes a receiving circuit for demodulating a received radio frequency signal output from an antenna and an antenna switching circuit for switching between sections connected to the antenna;
the second circuit includes a transmitting circuit for modulating a baseband signal into a radio frequency signal; and
the insulating base includes, as an inner layer, at least one ground layer for the first and second circuits.

5. The thin electronic circuit device according to claim 2, wherein:
the first circuit is covered with a first metallic cover;
the second circuit is covered with a second metallic cover; and
the external connection terminals are formed outside the second metallic cover.

6. The thin electronic circuit device according to claim 3, wherein:
the transmitting circuit is a frequency modulation transmitter; and
the receiving circuit is a frequency modulation tuner.

7. The thin electronic circuit device according to claim 6, wherein:
the first and second circuits include first and second phase-locked loop circuits, respectively; and
a microcomputer for controlling the first and second circuits and a reference signal generating circuit for supplying a reference signal to the first and second phase-locked loop circuits are provided on the motherboard.
